(19) United States
(12) Patent Application Publication
(10) Pub. No.: US 2021/0180796 A1
(43) Pub. Date: Jun. 17, 2021

(54) METHOD FOR OPERATING A COOKING APPLIANCE, AND COOKING APPLIANCE

(71) Applicant: E.G.O. Elektro-Geraetebau GmbH, Oberderdingen (DE)

(72) Inventors: Christian Egenter, Bretten (DE); Marcus Frank, Sulzfeld (DE); Frank Muenzner, Willingen (DE); Kay Schmidt, Oberderdingen (DE); Jonathan Berner, Vaihingen an der Enz (DE)

(21) Appl. No.: 17/247,405

(22) Filed: Dec. 10, 2020

(30) Foreign Application Priority Data
Dec. 17, 2019 (DE) 10 2019 219 808.2

(51) Int. Cl. F24C 7/08; H05B 6/06

(52) U.S. Cl. CPC F24C 7/083; F24C 7/087; H05B 2213/07; H05B 2213/05; H05B 6/062

(57) ABSTRACT

In a method for operating a hob using a smartphone as external operating device, the presence of an operator close to the hob is queried, this being able to be performed by a presence sensor or by operating elements on the hob itself. If the operator is present at the hob, then all of the operating commands from the smartphone are implemented at the hob. As soon as the presence of the operator is no longer able to be recorded at the hob, either no further operating commands from the smartphone are implemented or only operating commands by way of which a power of a heating device of the hob is reduced are implemented.

### CROSS-REFERENCE TO RELATED APPLICATIONS

This application claims priority to German Application No. 10 2019 219 808.2 filed Dec. 17, 2019, the contents of which are hereby incorporated herein in its entirety by reference.

### FIELD OF APPLICATION AND PRIOR ART

The invention relates to a method for operating a cooking appliance using an external operating device and to a cooking appliance designed for this purpose, wherein the cooking appliance has at least one heating device and a control device and at least one presence sensor device in order to be able to detect the presence of an operator at the cooking appliance.

It is known from DE 10 2013 214 929 A1 to operate a hob as cooking appliance using a mobile terminal as external operating device. A plurality of operators are thus able to work or cook at the hob, and cooking is also able to be made more sociable, as it were. Different operating possibilities and a distribution of priority between a control device on the hob and the external operating device are possible in this case, where this is considered to be practicable.

### PROBLEM AND SOLUTION

The invention is based on the problem of providing a method, mentioned at the outset, for operating a cooking appliance and a cooking appliance suitable for performing said method, by way of both of which problems from the prior art are able to be solved and it is in particular possible to be able to operate a cooking appliance using such an external operating device in a simple and safe and also reliable and practicable manner.

This problem is solved by a method having the features of claim 1 and by a cooking appliance having the features of claim 19. Advantageous and preferred refinements of the invention are the subject matter of the further claims and will be discussed in more detail below. In this case, some of the features are described only for the method or only for the cooking appliance. However, they are intended to be applicable, independently of this, both to the method and to the cooking appliance independently of one another. The wording of the claims is incorporated into the content of the description by express reference.

The cooking appliance has at least one heating device, advantageously a plurality of heating devices, a control device, which is conventional per se, advantageously a dedicated operating device with operating elements and a communication device that is preferably designed in wireless form. Provision is also made for at least one presence sensor device that is possibly arranged in the cooking appliance, in particular as part of the cooking appliance. As an alternative or in addition, a presence sensor device may also be arranged externally therefrom, but be connected to the cooking appliance so as to transmit signals. This signal transmission connection may be made via the communication device of the cooking appliance or else in another way. The at least one presence sensor device or all of the presence sensor devices and the communication device are furthermore connected to the control device. The control device is designed, inter alia, to control a supply of power to the heating device. In this case, it may in particular use power switches, which are known per se, to control the heating device in a desired or predefined manner, in particular switch it on and off and set the level of power generation.

The method has the following steps according to the invention. The cooking appliance is first of all switched on or is already switched on, for example including following a previous cooking operation. An operator then sets, directly on the cooking appliance or its abovementioned operating device, a remote operating mode for at least one heating device as input possibility for the abovementioned external operating device. This external operating device is connected to the communication device in the manner of a remote controller and interacts therewith, in particular wirelessly via radio. The external operating device is thus able to transmit operating commands to the communication device and thus to the control device, so that these are then performed by the control device, in particular by operating or changing the operation of the heating device. The external operating device may in this case be a special operating device only for this cooking appliance or for a family of cooking appliances, that is to say for this specific purpose. As an alternative, it may be an abovementioned mobile terminal such as a mobile telephone or a tablet computer. The external operating device is advantageously in this case connected wirelessly to the communication device. The presence sensor device in this case records the presence of the operator at the cooking appliance or close to the cooking appliance, that is to say whether the operator is at the cooking appliance. A distance between the operator and the cooking appliance or the presence sensor device that is less than 5 m or less than 3 m is in this case assessed to mean that the operator is present at the cooking appliance. Under this condition, in the case of a distance below said specifications, it may thus be assumed that the operator is at the cooking appliance and is monitoring the operation and operating state thereof This is important if a possible critical situation occurs, for example boiling over of food or burning of food or combustion of fat or oil.

In a 1st case, the presence of the operator is recorded at the cooking appliance, that is to say the abovementioned distance is dropped below. An operator is then at or close to the cooking appliance. Monitored and safe operation of the cooking appliance may thus be assumed, meaning that the cooking appliance is able to be operated by way of the external operating device. The operator, possibly using the external operating device, is thus at the cooking appliance and is able to recognize and assess an abovementioned possibly problematic or hazardous situation or to prevent this by intervening.

In another second case, the presence of the operator is not recorded at the appliance. Said operator is thus not nearby, or is not located at a distance below the abovementioned distance. Said operator is thus also not able to safely monitor or recognize the operation and a situation at the cooking appliance. This absence of the operator at the cooking appliance is recorded by the presence sensor device. In this second case, the control device does not execute any new operating commands or any further new or changed operating commands from the external operating device by way of which a power of a heating device of the cooking appliance is intended to be increased, that is to say the hazard level could be increased.

This advantageously applies to the time of the command input. If the operator is then not present at the cooking appliance, then the control device does not execute any new operating commands or any further new or changed operating commands from the external operating device by way of which a power of a heating device of the cooking appliance is intended to be increased. If the presence ceases shortly before the command input or shortly after the command input, this does not play any further role, and should advantageously remain unobserved. By virtue of recording presence, it is checked whether the operator is present as it were only at the time, and not for the entire duration of a cooking process.

In this second case, provision is thus made for a possibly present hazardous situation to at least not be made more critical or worse by way of an operation on the external operating device. Reducing a power of a heating device of the cooking appliance or switching it off may then still be possible by way of the external operating device. Although such an external operation does not, or not completely, rectify a possible hazardous situation, it helps to at least reduce it, possibly considerably reduce it. Such an operation may thus still be accepted and implemented by the control device, even when the presence of the operator is not recorded at the cooking appliance at this time or at this point in time of the operation.

The invention thus achieves a situation whereby an operation that could worsen a hazardous situation at the cooking appliance is possible only when the presence of the operator is recorded at the cooking appliance in this case. At the same time, however, the cooking appliance does not necessarily have to be switched off or the external operating device does not necessarily have to be completely deactivated when the operator is no longer close enough to the cooking appliance or presence is no longer recorded. This enables highly convenient and at the same time practicable and safe operation of the cooking appliance by way of the external operating device.

In one possible refinement of the invention, there may generally be provision for an operation directly on the cooking appliance to be executed with priority over an operation by way of the external operating device. This is based inter alia on the fact that, for direct operation on the cooking appliance by way of its operating device, the operator is definitively present in all cases at the cooking appliance, and there are thus absolutely no safety concerns. It must furthermore always be possible at least to reduce the power of a heating device, to switch it off or to switch off the entire cooking appliance at the cooking appliance itself, in particular including in the case of an abovementioned possible hazardous situation.

In yet another refinement of the invention, the distance up to which it is considered that an operator is present at the cooking appliance may be set at the cooking appliance itself. This may take place either when the cooking appliance is initially installed or else subsequently. It is thereby possible for example to take into account a specific installation situation of the cooking appliance in a kitchen, which may be considered to be the maximum distance here, and which is understood to mean the presence of the operator at the operating device within the context of possible supervision of the cooking appliance. Such a distance may be up to at most 5 m or even at most 10 m, since, beyond this distance, it is no longer necessarily able to be ensured that an operator is actually able to carefully and accurately monitor a process on the cooking appliance.

In a further refinement of the invention, it is possible, in the abovementioned second case, that is to say when the presence of the operator is no longer recorded at the cooking appliance, for only a reduction in the power of a heating device or of the heating device operated or controlled by the external operating device to be authorized or executed by the control device as operating command from this external operating device. It is thus possible for example for an operator holding the external operating device to be at a distance from the cooking appliance and for his presence at the cooking appliance no longer to be identified to a sufficient extent. If the communication device recognizes this, operating commands may then still be issued from the external operating device to the cooking appliance, by way of which operating commands a power of a heating device is reduced or this heating device is even completely switched off. This is ultimately a process that necessarily reduces a possible risk or a possible hazard at the cooking appliance, which is why it is even possible at all.

In one refinement of the invention, there may be provision, in the abovementioned second case, for a power of the heating device to be reduced automatically by the control device when the presence sensor device no longer identifies the presence of the operator at the cooking appliance. This may be performed as an alternative safety measure. Such an automatic reduction in the power may be by at least 20% to 50% or be from 1% or 10% to 50% of the maximum power of the heating device. Following such a reduction in the power of the heating device, it may be assumed that there is no longer (able to be) any acute hazard at the heating device. At the same time, a cooking vessel placed on the hob and containing food is at least still able to be kept warm as a compromise between safety and a desired result of a cooking operation. These values may possibly additionally also depend on whether the heating device was being operated with a low power, a medium power or a very high or its maximum power.

In a further refinement of the invention, when, following interruption of the presence of the operator at the cooking appliance as abovementioned second case, the presence of the operator at the hob is identified again, that is to say when the first case is present again, there are two possibilities of how to proceed. According to a first possibility, a previous operating state of the cooking appliance or of the heating device operated using the external operating device, as was prevailing when the second case occurred when it was identified that the operator is no longer present at the cooking appliance, may then be set directly. The previous operating state is thus assumed automatically.

According to a second possibility, there may be provision for it to be necessary for the operator to first of all confirm a new operation, which should then preferably take place at the cooking appliance or at its operating device. Only then is it possible to reproduce the previous operating state of the cooking appliance or of the heating device as was prevailing beforehand, or to increase a power. To this end, corresponding information may be transmitted to the operator as a requirement and/or for confirmation, such that said operator is explicitly informed that the desired cooking process was interrupted due to the lack of presence and is then able to be continued again following confirmation. According to the second possibility, even higher safety is thus provided in that an operator has to perform an active action in order to be able to resume or continue the operation, which is then however also possible.

In a first refinement of the invention, it is possible for said at least one presence sensor device to be arranged directly on or in the cooking appliance, such that an electrical connection is very easy. A presence sensor device integrated in the cooking appliance may be provided in order to record an operation by an operator and/or a change in a position and/or a weight of an item of cookware placed on the hob or to recognize people and/or movements in the region around the cooking appliance. It may be designed as a motion sensor, as a capacitive proximity sensor or as a reflex light corridor or as a radar sensor. As an alternative, the presence sensor device may also be a functional device on the cooking appliance itself or monitor same, for example a pot recognition sensor or a weight sensor on a hob zone of a hob that is able to record an operation or generally an action by the operator on the cooking appliance. Such an action on the cooking appliance then also naturally necessarily means that the operator is present at the cooking appliance or is standing directly in front of it. The presence sensor device or one of the presence sensor devices may also form or explicitly trigger an operation on the abovementioned operating device of the cooking appliance.

In a second refinement of the invention, it is possible for said at least one presence sensor device not to be arranged directly in or on the cooking appliance, but rather separately therefrom. In may then be a proximity sensor, an optical monitoring device such as a video camera or a motion detector or the like. It may advantageously be arranged at a distance of less than 3 m from the cooking appliance. According to one possibility, the presence sensor device may actually record the distance between an operator and the cooking appliance, in particular when it is a camera or the like. According to another possibility, the presence sensor device may be arranged relatively close to the cooking appliance and record a distance between the operator and itself, which is then evaluated just as the distance to the cooking appliance itself. Although the presence sensor device may also be connected in principle to the cooking appliance or its control device by way of a cable, a wireless connection via the abovementioned communication device is advantageously possible.

In a further refinement of the invention, it is possible for the external operating device to be able to control precisely a single heating device or functional device of the cooking appliance. To this end, there may be a prior explicit assignment of the external operating device to precisely this heating device or functional device. In another method or in another portion of this method, another heating device or functional device of this cooking appliance could then be controlled using the external operating device.

In another refinement of the invention, a plurality of heating devices or functional devices of the cooking appliance may be controlled using the external operating device. In this case too, an above-described explicit assignment of the external operating device to precisely these heating devices or functional devices is advantageously possible, this also being able to be changed.

In yet another refinement of the invention, the external operating device may control the entire cooking appliance. This may also be assigned or set beforehand. In this case, it should advantageously be possible, in all of the abovementioned refinements, for continued operation also to be possible using the operating device of the cooking appliance itself. This operation should then in each case also have priority over the operation using the external operating device, in particular for the safety reasons explained above. In the case of an operation directly on the cooking appliance, an operator in all cases has a better overview of the situation thereon than when using the external operating device.

In one development of the invention, the presence of the operator at the cooking appliance may be recorded repetitively or repeatedly. This is particularly advantageously recorded repeatedly at regular intervals. A temporal spacing of such a recording should be less than 1 min, so that a hazardous state is not able to occur. A temporal spacing is advantageously less than 10 sec or less than 1 sec. Continuous or completely gap-free permanent presence recording is considered not to be necessary and to be too complex. There may also be provision for the presence of the operator at the cooking appliance to be recorded or checked only when an operating command from the external operating device arrives or is received at the communication device. The information about the presence is required only at this point in time.

In a further development of the invention, it is possible for the presence sensor device to have a plurality of presence sensors and to be able to record the presence of the operator at the cooking appliance in various ways. This increases safety. There may thus be provision for example for an operating device to be used as presence sensor in addition to a camera as presence sensor. If this operating device identifies an input by the operator directly on the cooking appliance within the abovementioned temporal spacings or at the point in time of a command input, then the other presence sensor does not need to be activated. Such an operation of the cooking appliance itself is above all a reliable and unambiguous indicator that the operator is present at the cooking appliance and is additionally also devoting his attention to the cooking appliance.

In one basic refinement, the external operating device may be a mobile terminal, for example a smartphone, a tablet computer or a notebook computer. In another basic refinement of the invention, the external operating device may be a radio network, in particular what is known as a WLAN, or else the Internet, which is connected to the control device of the cooking appliance via the communication device. A cooking program on the cooking device is thus able to be transmitted to the control device or to the cooking appliance, for example including directly from the Internet. A multiplicity of cooking programs are thereby in particular able to be executed on the cooking appliance. For the smooth operation thereof with complete usage of the possibilities on the cooking appliance, in particular a power of one of the heating devices, it is then however necessary for the operator to be present at the cooking appliance. Otherwise, critical states could be set or occur at the cooking appliance, in particular triggered by such a cooking program, which should be avoided. In a further refinement, the external operating device may be what is known as an intelligent machine or an external automatic controller that assists the operator when cooking. Such a machine or external automatic controller may increase comfort for the operator or allow him to cook independently in spite of personal limitations and/or capabilities in the context of what is known as ambient assisted living, advantageously including to cook complex dishes.

The control device is designed not only to control the cooking appliance itself, in particular including following operation by an operator on the operating device of the cooking appliance itself, but also, together with the external operating device, to perform a method according to the invention. This means above all that the abovementioned safety measures as it were are implemented in the control device or are performed primarily thereby.

The invention advantageously makes it possible to maintain an approved state for the operation using the external operating device on the cooking appliance by recognizing the presence of an operator using sensors in or on the cooking appliance or close to the cooking appliance. This may be achieved in particular by evaluating the operation of operating elements that are not used directly for the approval, and/or of known pot recognition sensors that recognize a change in their coverage and thus also in the coverage of an associated heating device, and/or of weight sensors that use a stepped change to recognize the addition of pots or of food to a pot. These are operations that are performed directly on the cooking appliance by an operator. Pot recognition sensors are able to recognize both a change in their own coverage and thus also in the coverage of an associated heating device that is operated using the external operating device and such a change in another heating device that is not operated using the external operating device. These are all operations that an operator performs on the cooking appliance itself and thus necessarily indicate and identify the presence of at least one operator at the cooking appliance.

A cooking appliance, in particular a hob, which is supervised through the presence of an operator may, in one advantageous refinement of the invention, receive its operating commands generally from the Internet or a cloud from any source, including via a radio connection or network connection. External operating commands may also be for example operating commands via assistance systems such as Alexa, apps, cloud systems, abovementioned intelligent machines, external automatic controllers or the like. Although such a source controls the hob remotely via or as the external operating device, a hazardous state may no longer be assumed when an operator is present. If a hazardous state were to arise, a present operator could intervene immediately, for example by making a change on the control device of the cooking appliance as an operation, preferably in the form of a power reduction. This operation on the cooking appliance, as described above, always has priority and is also always possible. An operating command may be input for example on the smartphone as external operating device and recognized, processed in the cloud and then transmitted to the cooking appliance, in particular transmitted via the smartphone. It is first of all checked on the hob whether an operator is in situ and is present, that is to say is monitoring the hob, or at least in theory is able to monitor it or could recognize a hazardous state and could intervene. If this is the case, the operating command is forwarded to the control device and thus treated in the same way as an operation directly on the hob. This is explained in more detail below with reference to the figures. If, in the same example, the presence of a control device in situ has then not been recognized, the operating command is ignored by the control device, at least when it is intended to bring about a power increase, and the control device makes the operator aware of this through a signal. This signal makes the operator aware that firstly his presence at the hob was not able to be identified, and secondly the operating command was not executed. Such a signal may be output at the hob and/or on the smartphone.

In addition to the presence of an operator, it may be checked whether the external operating device has been authorized or registered to operate this cooking appliance. It is thus possible to rule out an arbitrary external operating device being able to generate a valid operating command for the cooking appliance.

In one refinement, recipes may be downloaded from databases. These recipes already contain the power settings or entire temperature profiles for the cooking appliance. The specifications are adopted completely and executed by the hob or its control device only when the presence of an operator is recognized.

In a further refinement, an item of cookware with its own temperature sensors is used as cooking appliance on a hob. This item of cookware transmits its temperature values wirelessly to a regulation device in the cloud, possibly via an external operating device. From there, the completely prepared power command is used as operating command to actuate a heating device by way of which this item of cookware is heated. The specifications are adopted and executed by the control device only when the presence of an operator is recognized. If it is then recognized that an operator is no longer present at the hob, the control device accordingly responds differently to the external operating commands. It does not adopt any further external operating commands if they are intended to bring about a power increase, but rather only if a power is intended to be reduced now or later by way of an external operating command. In this case, ongoing cooking processes, such as for example cooking rice, are able to be continued, but in the process any further operating commands that increase the power are no longer executed, but rather only those that reduce the power.

In another refinement, the control device may even no longer continue, that is to say stop, externally previously received operating commands. In yet another refinement, it may entirely switch off a heating device previously controlled via external operating commands.

Various technologies may be used to recognize the presence of an operator. The presence of an operator may be inferred both on the basis of sensors in the hob and on the basis of verified monitoring devices in the spatial surroundings around the hob. A change in the state of an abovementioned pot recognition system may be inferred due to the fact that an operator is present and pots have been placed on or removed from the hob or have generally moved. This may take place using conventional pot recognition sensors, see for example US 2004/0182852 A1, DE 102004016631 A1 or DE 102016217783 A1.

In a further refinement, the operator may be asked by the hob or an external input appliance to confirm his presence if the abovementioned internal presence recognition devices have not recognized him. This may take place for example through instructions such as “Please move the desired pan!”, which may be output acoustically through voice and/or optically.

Weight sensors underneath a hob zone may furthermore be used to measure a weight loading of the hob, see in this respect DE 10353299 A1. Changes in this weight loading may be used to infer the addition of food or movements by the operator. To the same end, instead of the weight, the acceleration of the hob zone may be measured, that is to say placement of an item of cookware on the hob zone. Motion detectors may likewise for example use pyroelectric sensors in the room to recognize that people are present.

A camera may create an image of a kitchen and identify the presence of people, in particular including close to the cooking appliance. In one additional refinement, it is possible to recognize facial features of an operator in order to additionally distinguish whether a previously registered and thus authorized operator is in front of the cooking appliance. It is thus possible for example to avoid children unwantedly being able to use or adjust the cooking appliance. As an alternative to a camera with optical evaluation, it is possible to use microwaves, radar or existing radio interfaces such as for example BLE or else RFID. Evaluation using a time-of-flight sensor system is also conceivable. Contactless temperature sensors are likewise conceivable. These are able to recognize the temperature of objects and compare it with the body temperature of the human body in order to determine whether an operator is present.

Speech or a voice of the operator may furthermore be recognized. By way of example, an external voice assistant may be connected and may also serve as presence sensor device. A microphone may additionally be integrated in the cooking appliance. The external voice assistant may recognize an operating command and transmit it to the hob or its control device. The microphone in the hob recognizes only noise of predefined duration and volume, which may be compared in this respect to the speech recognized from the external voice assistant. An operating command from the external voice assistant occurs in the immediate temporal proximity to the recognition on the microphone of the hob. This verifies that the operator is present at the hob, and the operating command from the voice assistant thus cannot lead to any hazardous state of the hob. A possibly complex voice recognition system then does not have to be integrated in the hob itself. Although this should exclude a recognized voice coming from a playback appliance, for example a television or radio. This is possible as a result of the comparison between the voice assistant and the microphone of the hob, since the voice assistant is only able to compare the microphone of the hob at all if it recognizes an appropriate operating command. Otherwise, definitively no operating command is generated, and then also does not have to be checked with regard to the presence of the operator at the cooking appliance. As an alternative, other presence recognition technologies or the combination of abovementioned technologies are possible. A voice recognition system in a mentioned voice assistant may additionally transmit the identified voice pattern as data to the hob for a plausibility comparison. The hob may then compare the recognized voice pattern with the transmitted pattern from the voice assistant. The hob does not however have to perform or take over decoding of the voice itself, this being complex, but rather only has to compare its recognized pattern with the transmitted pattern from the voice assistant.

In a further refinement, in addition to the pure presence of an operator, for additional safety, vital parameters of a present operator may also be determined, for example body temperature, movement speed, activity state with regard to fall recognition or heartbeat, in order to obtain a quality criterion for the operator. It is thus possible to check whether said operator, in addition to his pure presence, also is or is able to be sufficiently attentive.

These and further features will emerge not only from the claims but also from the description and the drawings, wherein the individual features may be realized in each case individually or severally in the form of sub-combinations in an embodiment of the invention and in other fields, and may constitute advantageous and independently protectable embodiments for which protection is claimed here. The division of the application into individual sections and subheadings does not mean that the statements made under these are restricted in terms of their general applicability.

### BRIEF DESCRIPTION OF THE DRAWINGS

Exemplary embodiments of the invention are schematically illustrated in the drawings and will be discussed in more detail below. In the drawings:

FIG. 1 shows a schematic illustration of a hob as cooking appliance according to the invention, on which the operating method according to the invention is explained, wherein the presence of an operator close to the hob is recognized, and

FIG. 2 shows the hob from FIG. 1 during the operating method, in which the presence of the operator at the hob has no longer been recognized.

### DETAILED DESCRIPTION OF THE EXEMPLARY EMBODIMENTS

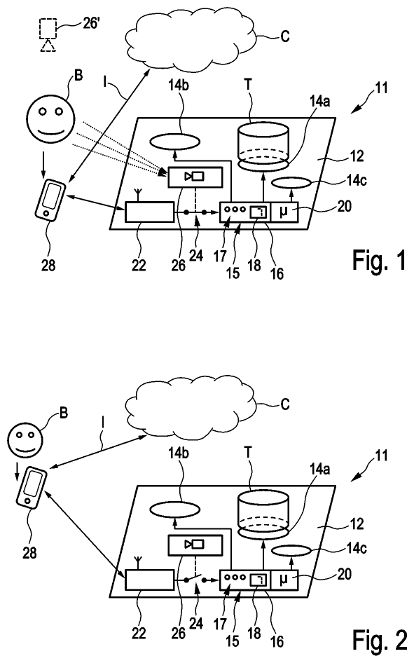

FIG. 1 illustrates a hob 11 according to the invention as abovementioned cooking appliance. The hob 11 has a hob zone 12, under which three induction coils 14a, 14b and 14c are arranged as abovementioned heating devices. The induction coils 14a to 14c are supplied with power in the usual way, in particular from a power supply with converters that are actuated by a hob controller 15 with a microcontroller 20 as control device. For the sake of simplicity, the actuation of the induction coils 14a to 14c is illustrated directly here. The hob controller also has another operating panel 16 as operating device for the hob 11. The operating panel 16 has a plurality of operating elements 17 that may be designed in a known manner, for example as touch switches or as a touch display. A display 18 is provided, either as a possibly multi-digit seven-segment display, known per se, with LEDs or as an LCD display or part of an abovementioned touch display.

The hob 11 has a communication device 22 that is designed, through the antenna symbol, as a wireless communication device. It may for example operate using WLAN or Wi-Fi, alternatively in accordance with any radio standard, for example including Bluetooth or BLE. The communication device 22 interacts with the hob controller 15 via a forwarding system 24, which may be interrupted and is therefore illustrated here as a type of switch. It may in particular forward operating commands, as has been explained above and as is set forth in detail below. The hob 11 is designed for an abovementioned remote operation mode.

The forwarding system 24 or its switches may be interrupted through the action of the presence sensor 26, as is illustrated by the dashed connection. In practice, the presence sensor 26 advantageously interacts with the communication device 22 or with the hob controller 15. The presence sensor may be for example a camera, illustrated here within the hob 11. As an alternative, a camera 26′ may also be arranged outside the hob 11 in a kitchen in which the hob 11 is installed. The external camera 26′ may then communicate with the hob 11 via a radio connection or in a wired manner, for example including by way of the communication device 22 itself, and in particular transmit information in order to determine a sufficient presence of an operator B at the hob 11. The influence of the presence of the operator B at the hob 11, which may be given in FIG. 1 through a distance of less than preferably 3 m, for example because the operator B is standing directly in front of the hob 11, is illustrated by the three dotted arrows toward the presence sensor 26. The abovementioned 1st case according to the invention is thus present.

Instead of a camera as presence sensor 26, it is also possible to use other ones of the abovementioned possibilities, meaning that an operation on the hob controller 15 or on the operating panel 16 may also be assessed as such presence. A pot recognition system by way of one of the induction coils 14a to 14c, which is known to a person skilled in the art, may also be used. If a pot T on an induction coil, such as for example here on the induction coil 14a, is moved by the operator B, then this may be recognized on the induction coil 14 itself and assessed as the reliable presence of the operator B at the hob 11.

The operator B may transmit operating commands to the hob 11 by way of a smartphone 28 as abovementioned external operating device in the remote operating mode or transmit them to the communication device 22, which then forwards them to the hob controller 15 on the condition of recognized presence according to FIG. 1. The induction coil 14a with the pot T on top of it may thus, for example, then be operated by the operator B including solely via the smartphone 28, in particular be changed as desired with regard to its power. This is possible because the 1st case applies.

An Internet connection I of the smartphone 28 to a cloud C is also illustrated. This means that it is possible for example for cooking programs or the like to be loaded from the cloud C onto the smartphone 28, possibly modified there, and then transmitted to the communication device 22 as control commands for implementation by the hob controller 15 either through intervention by the operator B himself or by a cooking program running on the smartphone 28. Further possibilities for the interaction between the smartphone 28 and the cloud C have been explained above.

FIG. 2 then illustrates, through a much smaller illustration of the operator B, how said operator, together with the smartphone 28, has moved away from the hob 11, in particular beyond the abovementioned distance of 3 m or even 5 m. The abovementioned 2nd case according to the invention is thus present. A telephone call may for example be received on a smartphone 28, the operator then answering this and moving away from the hob 11, that is to say no longer being present. He is then no longer able to monitor a progress, in particular a cooking process in the pot T on the induction coil 14a, and is not able to recognize a possibly occurring critical situation. The presence sensor 26 in the hob 11, alternatively an externally arranged camera 26′, are not only no longer able to record the presence of this specific operator B at the hob 11, but rather are not able to record any presence of any person, whether or not this person has previously operated the hob 11 or wishes or does not wish to operate it. Although the smartphone 28 thus has an intact connection to the communication device 22 even in the case of recognizing that the operator B is no longer present at the hob 11, the presence sensor 26 has disconnected the forwarding system 24. The disconnection advantageously takes place at the time when the presence sensor 26 recognizes that the operator B is too far away from the hob 11 or is no longer close enough to the hob 11. This may be performed at a conventional sampling rate of the presence sensor device, which may be for example in the range from below 1 sec to up to 1 sec or may extend up to 10 sec. As an alternative, there may generally be provision for the presence sensor 26 to recognize that the operator B has moved away from the hob 11 but, for as long as no operating command comes from the smartphone 28, nothing about the state needs to be changed. The other possibility described above is however preferred.

If an operating command is then input on the smartphone 28 either directly by the operator B, possibly even unintentionally, or by an automatic cooking program running thereon, possibly interacting with the cloud C, then, in the exemplary embodiment illustrated in FIG. 2, this operating command is not forwarded to the hob controller 15 at all due to the disconnected forwarding system 24. The hob controller 15 does not implement this command in any case. This is the safety measure according to the invention, since the operator B is obviously not able to check whether a critical or hazardous state could occur on the hob 11, triggered by this operating command. As a departure from this method, there could also be provision for the forwarding system to be made attentive as it were, but only to be disconnected, or for an operating command to no longer be transmitted to the hob controller 15 by the smartphone 28 or to no longer be executed by said hob controller if this operating command would result in an increase in the power of the induction coil 14b for the pot T. A reduction in the power of the induction coil 14a as external operating command may then be implemented even by the hob controller 15, since the heating power thereof thereby decreases and the risk of a critical state at the hob 11 is at least reduced, if not even possibly completely eliminated. An operating command to switch off the induction coil 14a would of course also expediently be implemented, since this would definitively again result in a further reduction in the risk of a hazardous situation. Such an external operating command to reduce the power or to switch off the induction coil 14a may have been input intentionally by the operator B, possibly during the absence, as a safety measure. This is then advantageous because this is also implemented in this way in order to reduce the risk. The operator is thus able to reduce the power for the induction coil 14a from power level 7, illustrated on the display 18, for example to a power level 3 or 4, even from relatively large distances for safety reasons. Although the pot T is thereby still kept warm or hot, no further critical states are able to occur. Even pasta water threatening to boil over usually no longer boils over at such a power level.

Instead of a hob 11, an oven could also form the cooking appliance according to the invention, alternatively a pressure cooker, a grill or the like. In the case of these cooking appliances as well, an external operation using a smartphone or the like may be advantageous, in particular for performing cooking programs with regard to a power/time profile. There is then also advantageously provision here for the presence of an operator to be necessary at least in order to increase a power on a heating device, at least at the point in time of this desired power increase.

As a further safety measure, it is possible for the hob controller 15 to automatically reduce a power of the induction coil 14a that was operated previously by way of the smartphone 28 in the event that the presence sensor 26 no longer identifies the presence of the operator B at the hob 11. A power reduction may take place by the abovementioned values, but this should be sufficient to avoid a hazardous situation. A power should thus be reduced by at least 20% to 50% or be reduced by 1% or 10% to at most 50% of the maximum heating power of the induction coil 14a. However, it is in no case still possible to externally increase the power. When automatically reducing the power for safety reasons, the power for the induction coil 14a may thus be reduced for example automatically from power level 7 shown on the display 18 to a power level 3 or 4, similarly to as described above.

If, following the absence of the operator B at the hob 11 according to FIG. 2, it is identified that the operator B is now back at the hob 11 according to FIG. 1, for example because an operating command has been input or because a camera 26′ has recognized this, then the operating state of the hob 11 and in particular of the induction coil 14a as were prevailing when the absence was discovered may possibly be set again. As an alternative, it may be necessary for an operator B to be made aware, through a signal, for example optically and/or acoustically on the operating panel 16, that confirmation of the presence is necessary. One of the operating elements 17 then for example has to be operated by the operator B, so that a normal operating process is then possible by way of the smartphone 28 as external operating device.

In a further refinement of the invention, it is also possible for the smartphone 28 not to be required as external operating device, but rather the cloud C forms this external operating device by way of an Internet connection I directly to the communication device 22. An operator B may have selected a cooking program from the cloud C on the operating panel 16. It is then the case that, although operating commands are transmitted to the hob controller 15 from the cloud C, a power is increased at a controlled induction coil 14a only when an operator B is present at the hob 11.

1. A method for operating a cooking appliance using an external operating device, wherein said cooking appliance has:
at least one heating device,
a control device,
at least one presence sensor device for recognizing a presence of an operator,
a communication device,
wherein said at least one presence sensor device and said communication device are connected to said control device, and
wherein said control device controls a supply of power to said heating device,
with the following steps:
said cooking appliance is switched on or is already switched on,
an operator sets, directly on said cooking appliance, a remote operating mode for one of said heating devices for an input possibility for said external operating device, wherein said external operating device interacts with said communication device in order to transmit operating commands to said communication device for execution on said heating device by said control device,
said presence sensor device records a presence of said operator at said cooking appliance or close to said cooking appliance, wherein in this case a distance between said operator and said cooking appliance or said presence sensor device of less than 5 m is assessed as said operator being present at said cooking appliance,
in a 1st case, in which said presence of said operator is recorded at said cooking appliance, operation of said cooking appliance by way of said external operating device is possible, and operating commands from said external operating device are executed by said control device,
in a 2nd case, in which said presence of said operator is not recorded at said cooking appliance, no further operating commands from said external operating device for bringing about an increase in a power of one of said heating devices of said cooking appliance are executed by said control device.

2. The method as claimed in claim 1, wherein an operation directly on said cooking appliance is executed with priority over an operation by way of said external operating device.

3. The method as claimed in claim 1, wherein a distance between said operator and said cooking appliance or said presence sensor device that is assessed as said operator being present at said cooking appliance is settable up to at most 5 m.

4. The method as claimed in claim 1, wherein, in said 2nd case, only a reduction in a power of said heating device is authorized and executed by said control device as operating command from said external operating device.

5. The method as claimed in claim 1, wherein, in said 2nd case, a power of said heating device is reduced automatically when said presence sensor device no longer identifies said presence of said operator at said cooking appliance.

6. The method as claimed in claim 5, wherein said power of said heating device is reduced by at least 20% to 50% or is reduced by 1% to 50% of said maximum power of said heating device.

7. The method as claimed in claim 1, wherein, in an event that, following interruption of said presence of said operator at said cooking appliance as said 2nd case, presence of said operator at said cooking appliance is identified again as said 1st case,
either a previous operating state of said heating device as was prevailing at an occurrence of said 2nd case, when said absence of the operator at said cooking appliance was identified, is set directly,
or it is necessary for said operator to confirm a new operation, so that a previous operating state of said cooking appliance or of said heating device is then reproduced.

8. The method as claimed in claim 7, wherein corresponding information is transmitted to said operator as a requirement and/or for confirmation for said new operation for confirmation by said operator, so that said previous operating state of said cooking appliance or of said heating device is then reproduced.

9. The method as claimed in claim 1, wherein said presence sensor device is arranged directly on or in said cooking appliance, wherein provision is made for said presence sensor device, integrated in said cooking appliance, for recording an operation by said operator and/or a change in a position and/or a weight of an item of cookware placed on said hob or for recognizing people and/or movements in a region around said cooking appliance.

10. The method as claimed in claim 1, wherein said presence sensor device is arranged at a distance of less than 5 m from said cooking appliance.

11. The method as claimed in claim 10, wherein said presence sensor device is not provided directly on said cooking appliance.

12. The method as claimed in claim 1, wherein precisely one single of said heating devices is controlled using said external operating device in accordance with an explicit assignment of said external operating device to precisely said heating device.

13. The method as claimed in claim 1, wherein a plurality of said heating devices are controlled using said external operating device in accordance with an explicit assignment of said external operating device to precisely said heating devices.

14. The method as claimed in claim 1, wherein said entire cooking appliance is controlled using said external operating device in accordance with an explicit assignment of said external operating device to said entire cooking appliance.

15. The method as claimed in claim 1, wherein said presence of said operator at said cooking appliance is recorded repetitively or repeatedly.

16. The method as claimed in claim 15, wherein said presence of said operator at said cooking appliance is recorded repetitively or repeatedly at time intervals of less than 1 min.

17. The method as claimed in claim 1, wherein said external operating device is a mobile terminal as a smartphone or a tablet computer.

18. The method as claimed in claim 1, wherein said external operating device is an intelligent machine for assisting said operator or an external automatic controller, a radio network or the Internet or a cloud.

19. A cooking appliance having:
at least one heating device,
a control device,
a presence sensor device for recognizing a presence of an operator,
a communication device,
wherein said presence sensor device and said communication device are connected to said control device, and wherein said control device controls a supply of power to said heating device,
wherein said control device is designed to perform a method as claimed in claim 1 using an external operating device.
